(19) United States
(12) Patent Application Publication
(10) Pub. No.: US 2018/0314975 A1
(43) Pub. Date: Nov. 1, 2018

(54) ENSEMBLE TRANSFER LEARNING

(71) Applicant: Futurewei Technologies, Inc., Plano, TX (US)

(72) Inventors: Hui Zang, Santa Clara, CA (US); Zonghuan Wu, Cupertino, CA (US); Jiangsheng Yu, San Jose, CA (US)

(21) Appl. No.: 15/499,660

(22) Filed: Apr. 27, 2017

(51) Int. Cl. G06N 99/00

(52) U.S. Cl. CPC G06N 99/005

(57) ABSTRACT

An apparatus and method are provided for ensemble transfer learning. One or more first (machine learning) projects that are similar to a second (machine learning) project are identified by comparing metadata of the one or more first projects and the second project, where the metadata comprises a plurality of characteristics and the characteristics of the first projects are compared to the characteristic of the second project to identify the one or more first projects. One or more (machine learning) models associated with the one or more first projects are selected as a plurality of models that each share a common feature set with the second project. Each model in the plurality of models is applied to input data for the second project to generate a set of results. Output data corresponding to the input data is produced for the second project based on the set of results.

The present disclosure relates to machine learning, and more particularly to an ensemble transfer learning technique for using existing machine learning models to generate an ensemble model.

### BACKGROUND

Over the past few years, machine learning has dominated approaches to solving many important problems in computing such as speech recognition, machine translation, handwriting recognition and many computer vision problems such as face, object and scene recognition. Existing machine learning techniques include transfer learning, ensemble learning, incremental learning, and reinforcement learning. The accuracy of a machine learning system depends on the development and training of a machine learning model. The training requires large amounts of raw data and data science expertise to develop and tune the machine learning model.

### SUMMARY

According to one embodiment of the present disclosure, there is provided an apparatus for ensemble transfer learning. Included are a non-transitory memory storing instructions and one or more processors in communication with the non-transitory memory. The one or more processors execute the instructions to identify one or more first machine learning projects that are similar to a second machine learning project by comparing metadata of the one or more first machine learning projects and the second machine learning project, wherein the metadata comprises a plurality of characteristics and the characteristics of the first machine learning projects are compared to the characteristic of the second machine learning project to identify the one or more first machine learning projects. One or more machine learning models associated with the one or more first machine learning projects are selected as a plurality of machine learning models that each share a common feature set with the second machine learning project. Each machine learning model in the plurality of machine learning models is applied to input data for the second machine learning project to generate a set of results. Output data corresponding to the input data for the second machine learning project is produced based on the set of results.

According to one embodiment of the present disclosure, there is provided a method comprising identifying one or more first machine learning projects that are similar to a second machine learning project by comparing metadata of the one or more first machine learning projects and the second machine learning project, wherein the metadata comprises a plurality of characteristics and the characteristics of the first machine learning projects are compared to the characteristic of the second machine learning project to identify the one or more first machine learning projects. One or more machine learning models associated with the one or more first machine learning projects are selected as a plurality of machine learning models that each share a common feature set with the second machine learning project. Each machine learning model in the plurality of machine learning models is applied to input data for the second machine learning project to generate a set of results. Output data corresponding to the input data for the second machine learning project is produced based on the set of results.

According to one embodiment of the present disclosure, there is provided a non-transitory computer-readable media storing computer instructions. When the computer instructions are executed by one or more processors, the one or more processors perform the steps of identifying one or more first machine learning projects that are similar to a second machine learning project by comparing metadata of the one or more first machine learning projects and the second machine learning project, wherein the metadata comprises a plurality of characteristics and the characteristics of the first machine learning projects are compared to the characteristic of the second machine learning project to identify the one or more first machine learning projects. One or more machine learning models associated with the one or more first machine learning projects are selected as a plurality of machine learning models that each share a common feature set with the second machine learning project. Each machine learning model in the plurality of machine learning models is applied to input data for the second machine learning project to generate a set of results. Output data corresponding to the input data for the second machine learning project is produced based on the set of results.

Optionally, in any of the preceding embodiments, the one or more processors execute the instructions to select the plurality of machine learning models from a set of machine learning models including machine learning models associated with the one or more first machine learning projects. Optionally, the one or more processors execute the instructions to compare a training dataset of each machine learning model in the set of machine learning models to the input data to select the plurality of machine learning models. Optionally, the one or more processors execute the instructions to compare features in a training dataset of each machine learning model in the set of machine learning models with features in the input data to identify the common feature set including at least a minimum number of features shared between each machine learning model in the set of machine learning models and the second machine learning project.

Optionally, the one or more processors execute the instructions to compare features in a training dataset of each machine learning model in the set of machine learning models with features in the input data to identify the common feature set including features shared between machine learning models in the set of machine learning models and the second machine learning project. Optionally, the one or more processors execute the instructions to exclude machine learning models in the set of machine learning models for which a number of features in the common feature set is less than a threshold value to produce the plurality of machine learning models.

Optionally, in any of the preceding embodiments, the one or more processors execute the instructions to exclude each machine learning model in the set of machine learning models for which a fraction of features for the machine learning model that are also features for the second project is less than a threshold value to produce the plurality of machine learning models.

Optionally, in any of the preceding embodiments, the one or more processors execute the instructions to retrain each machine learning model in the plurality of machine learning models using the common feature set before the machine learning model is applied to the input data.

Optionally, in any of the preceding embodiments, the one or more processors execute the instructions to determine the input data is not associated with a first feature, remove the first feature from a training dataset for a first machine learning model in the plurality of machine learning models to produce a modified training dataset, and retrain the first machine learning model using the modified training dataset. Optionally, the one or more processors execute the instructions to evaluate accuracy of the retrained first machine learning model, and before applying the first machine learning model to the new input data, exclude the retrained first machine learning model from the plurality of machine learning models when the accuracy is less than a threshold value from the plurality of machine learning models.

Optionally, in any of the preceding embodiments, the one or more processors execute the instructions to, for each machine learning model in the plurality of machine learning models, weigh a result value in the set of results that is produced by the machine learning model by an accuracy of the machine learning model to produce a set of weighted result values, and average the weighted result values to produce the output data.

Optionally, in any of the preceding embodiments, the one or more processors execute the instructions to, for each one of the result values in the set of results, select a result value that is predicted by a majority of the plurality of machine learning models to produce the output data.

Optionally, in any of the preceding embodiments, the one or more processors execute the instructions to, for each one of the result values in the set of results, select a result value that is predicted by a weighted majority of the plurality of machine learning models to produce the output data.

To this end, in some optional embodiments, one or more of the foregoing features of the aforementioned apparatus, system and/or method may enable reuse of one or more existing models associated with existing projects for a new project.

It should be noted that the aforementioned potential advantages are set forth for illustrative purposes only and should not be construed as limiting in any manner.

### BRIEF DESCRIPTION OF THE DRAWINGS

FIG. 1 illustrates a method for performing ensemble transfer learning, in accordance with one embodiment.

FIG. 2 illustrates an ensemble transfer learning platform, in accordance with one embodiment.

FIG. 3 illustrates operations of the method shown in FIG. 1, in accordance with one embodiment.

FIG. 4A illustrates another method for performing ensemble transfer learning, in accordance with one embodiment.

FIG. 4B illustrates operations of the method shown in FIG. 4A, in accordance with one embodiment.

FIG. 4C illustrates a generation of a plurality of models operation of the method shown in FIG. 4A, in accordance with one embodiment.

FIGS. 5A and 5B illustrate a conceptual diagram of ensemble transfer learning, in accordance with one embodiment.

FIGS. 6A, 6B, and 6C illustrate an output data computation operation of the method shown in FIGS. 1 and 4A, in accordance with one embodiment.

FIG. 7 illustrates a network architecture, in accordance with one embodiment.

FIG. 8 illustrates an exemplary processing system, in accordance with one embodiment.

### DETAILED DESCRIPTION

Development of a machine learning model (e.g., classifier) is typically costly in terms of time and requires large amounts of data, particularly for a training dataset. A data scientist's expertise may be used to develop the training dataset, select features (variables), select an algorithm, and tune the machine learning model. The training dataset includes input data and output data. The output data are results (i.e., predictions) that the machine learning model should generate in response to the input data. The input data may include values for a variety of different attributes and a set of features is identified that are most relevant to generate the correct predictions for the problem being solved or question being answered by the machine learning model.

As described further herein, existing projects may be identified that are similar to a new project and existing models may be used to generate new models for the new project. In the context of the following description, projects that are similar are projects that match each other. Ensemble transfer learning uses both ensemble and transfer machine learning techniques to generate the new models. The new models may be generated even when only a small amount of training data is available for the new project or even if no training data is available for the new project.

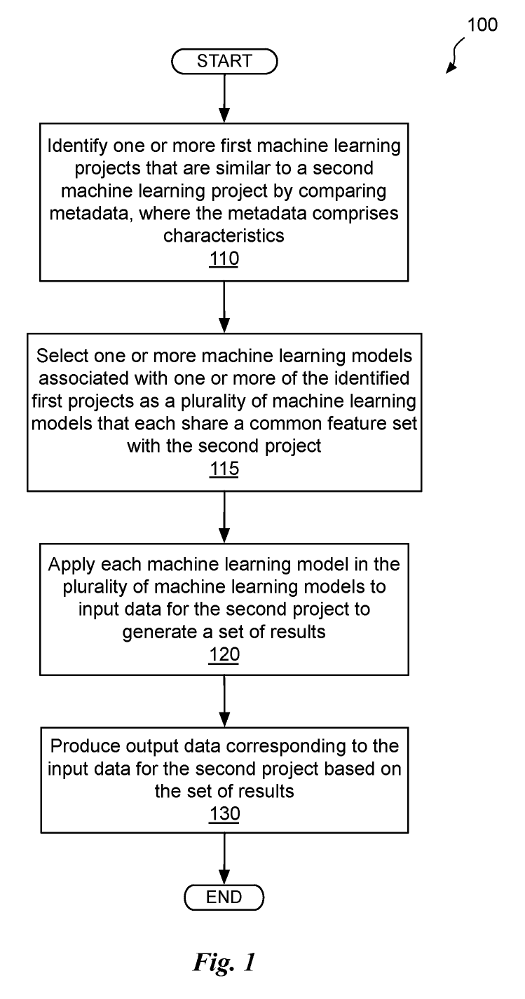

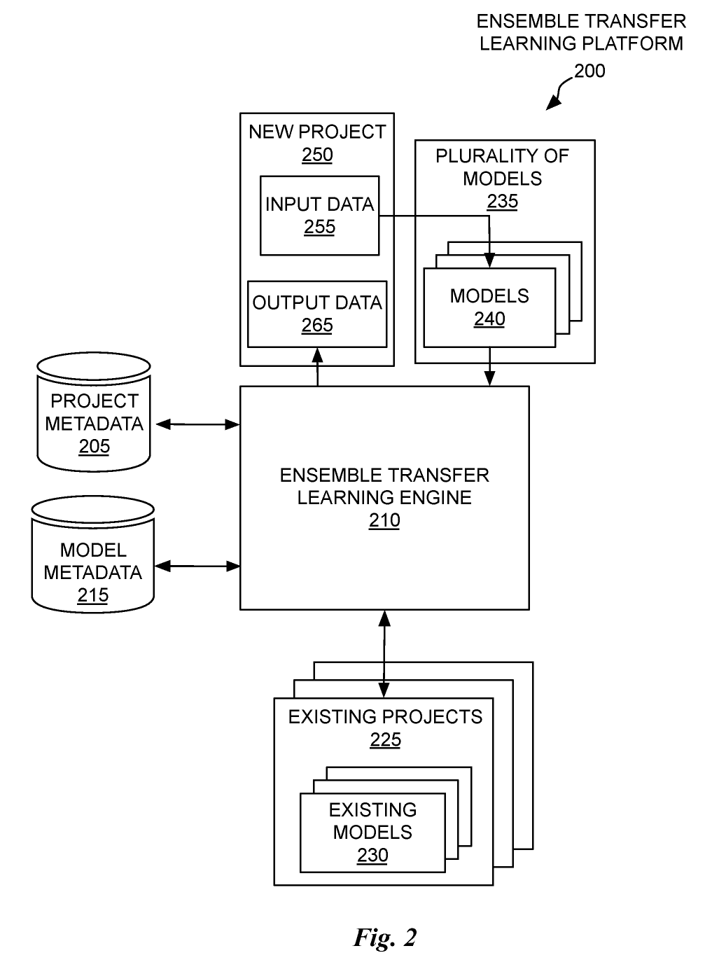

FIG. 1 illustrates a method 100 for performing ensemble transfer learning, in accordance with one embodiment. As an option, the method 100 may be implemented in the context of any one or more of the embodiments set forth in any previous and/or subsequent figure(s) and/or the description thereof. For example, in one possible embodiment, the method 100 may be implemented in the context of the ensemble transfer learning platform 200 of FIG. 2. However, it is to be appreciated that the method 100 may be implemented in other suitable environments.

As shown, in operation 110, existing projects in an ensemble transfer learning platform are compared to identify at least one project of the existing projects that is similar to a new project in the ensemble transfer learning platform based on project metadata. In one embodiment, the existing projects may be ranked according to how similar each existing project is compared with the new project. A fixed number of the existing projects may be selected from the ranked existing projects to generate the at least one project. Alternatively, a variable number of the existing projects may be selected from the ranked existing projects based on the similarity between the ranked existing projects and the new project. For example, existing projects that are at least 70% similar to the new project may be selected from the ranked existing projects.

In one embodiment, the project metadata includes references or names of one or more machine learning models associated with the project, project characteristics, a project feature set that includes features used by the models associated with the project, and a project label set that includes labels used by the models. Projects may be used in many different application categories, some of which include fraud detection, health diagnosis, purchase recommendations, and traffic navigation. In one embodiment, at least a portion of the project metadata is used to determine similarity between the new project and each of the existing projects. For example, one or more characteristics of a project that are included in the project metadata may be used to determine similarity between the project and another project. Examples of characteristics may include one or more of a brief description of the problem being solved (e.g., identity fraud, churn prediction, credit score prediction, gender prediction, credit card fraud, telecom fraud, securities fraud, etc.), the vertical industry where the problem exists (e.g. finance, telecommunications, healthcare, retail, etc.), whether the problem is a binary or multinomial classification, the entities being modeled/predicted (i.e. does the dataset correspond to people, phones, a product type, medicine, etc.), a type of the input data (e.g., census data, phone logs, patient symptoms, etc.).

In the context of the following description a label is a result or prediction that is produced as the output data of model that is usually included in training data. Examples of labels for a health diagnosis application of a machine learning model may include healthy, sick, and more specific labels such as malaria, yellow fever, etc. Examples of labels related to credit card transactions may include suspicious activity, credit card fraud, stolen credit card, etc. The model generates a value for one or more labels and the value may be true/false or a probability (percentage). During training, the results generated by the model may be compared with the label values in the training dataset to measure accuracy of the model. The training dataset is referred to as “labeled data” because correct results are provided as label values along with the input data. When a desired accuracy is achieved during training, the model may be deployed to generate results for unlabeled input data.

In operation 115, a plurality of models corresponding to the at least one project of the first projects is generated based on features of the first models and the input data for the new project that includes a dataset for the new project. In the context of the following description the first projects and the first models may be existing projects and existing models, respectively. In one embodiment, an ensemble transfer learning engine selects a plurality of models from a set of models that includes at least a portion of the models associated with the at least one project of the first projects. The features of each first model associated with the at least one project of the first projects may be compared with features extracted from the input data for the new project. In one embodiment, the first models having a minimum number of features in common with the new project are included in the set of models and the first models having less than the minimum number of features in common with the new project are not included in the set of models.

In one embodiment, the plurality of machine learning models are selected from a set of machine learning models that includes all of the models associated with the at least one project. In one embodiment, the plurality of machine learning models are selected based on model metadata for the at least one project and the project metadata of the new project. The model metadata for each machine learning model may include a training dataset, features, classification algorithm, accuracy, etc. The model metadata is described in further detail in conjunction with FIG. 2.

In one embodiment, the models in the set of models may be ranked according to the relevance of each model based on the project metadata of the new project. A fixed number of the models may be selected from the ranked models in the set of models to generate the plurality of models. A variable number of the models may be selected from the ranked models in the set of models, based on the relevance of each of the ranked models, to generate the plurality of models.

As shown, in operation 120, a plurality of machine learning models corresponding to the at least one project are applied to input data for the new project to generate a set of results. In operation 130, output data corresponding to the input data is produced for the new project based on the set of results. Importantly, the set of results includes results generated by each one of the models in the plurality of models when the model is applied to the input data for the new project. In one embodiment, the results for the models in the plurality of models are combined for each label to produce the output data. For example, when the result values are probabilities or percentages, the results for a label for each model in the plurality of machine learning models may be averaged to produce an output value for the label for the new project. In another example, the results for a label for each model in the plurality of machine learning models are each weighted by an accuracy of the model and the weighted results are averaged to produce an output value for the label for the new project. When the result values are true/false, a result value that is predicted (i.e., produced) by either a strict majority or weighted majority of the models in the plurality of machine learning models may be selected as the output value for the label for the new project. In the context of the following description, the plurality of models form an ensemble transfer machine learning model for the new project.

More illustrative information will now be set forth regarding various optional architectures and uses in which the foregoing technique may or may not be implemented, in accordance with other embodiments. It should be strongly noted that the following information is set forth for illustrative purposes and should not be construed as limiting in any manner. Any of the following features may be optionally incorporated with or without other features described.

FIG. 2 illustrates an ensemble transfer learning platform 200, in accordance with one embodiment. As shown, the ensemble transfer learning platform 200 is a system that includes an ensemble transfer learning engine 210, existing projects 225, project metadata 205, model metadata 215, a new project 250, and a plurality of models 235. In one embodiment, the ensemble transfer learning engine 210 is a processing engine that may be implemented by an apparatus comprising a non-transitory memory storing instructions and one or more processors in communication with the non-transitory memory, where the one or more processors execute the instructions to perform the operations shown in FIG. 1. In one embodiment, the ensemble transfer learning platform 200 is implemented in a cloud environment. It should be noted that the communication between the foregoing components of the ensemble transfer learning platform 200 may be afforded by way of any type of networking (e.g. bus networks, local networks, remote networks, etc.).

Further, while the various components are shown to be separate and discrete in one possible embodiment, other optional embodiments are contemplated where one or more components (or even all) are integrated in a single component. To this end, each of the illustrated components of the ensemble transfer learning platform 200 may include any combination of software and/or hardware capable of performing their intended tasks that will be elaborated upon below, and may or may not share underlying hardware with one or more of the other components of the ensemble transfer learning platform 200. The illustrated components can communicate with each other using one or more data communication networks such as, for example, the Internet. More information will now be set forth regarding each of the foregoing components and the interoperability thereof.

The existing projects 225 may include one or more existing projects 225 and each existing project 225 includes at least one existing model 230. As shown, metadata for the one or more existing projects 225 is stored in a data storage means in the form of the project metadata storage 215. In one embodiment, the ensemble transfer learning engine 210 saves a record of each existing project 225 in the project metadata 205. As previously explained, for each existing project 225, the project metadata 205 may include references or names of the one or more existing models 230 associated with the existing project 225, project characteristics, a project feature set that includes features used by the existing models 230, and a project label set that includes labels produced by the existing models 230. A project dataset for each existing project 225 includes the one or more existing models 230, model metadata 215 associated with the existing models 230, and project metadata 205 associated with the existing project 225.

As shown, an abstract representation of each existing model 230 is stored in a data storage means in the form of the model metadata storage 215. An abstract representation of each of the models 240 may also be stored in the model metadata storage 215. The abstract representation may include attributes such as a name (i.e., unique identifier), the algorithm type, the classification algorithm, the number of features, the features (e.g., name and type, such as integer, float, binary, multi-categorical, etc.), accuracy, a brief description of the problem being solved (e.g., credit card fraud, telecom fraud, securities fraud, etc.), the industry where the problem exists (e.g. finance, telecommunications, retail, etc.), and the like. The entire problem description or one or more keywords in the problem description, for example, can be used as a characteristic to identify similar projects. Example algorithm types include classification, clustering, deep neural network (DNN), convolutional neural network (CNN), and recurrent neural network (RNN). Example classification algorithms include logistic regression, linear regression, decision tree, support vector machine (SVM), k-nearest neighbors (KNN), Naïve Bayes, and random forest.

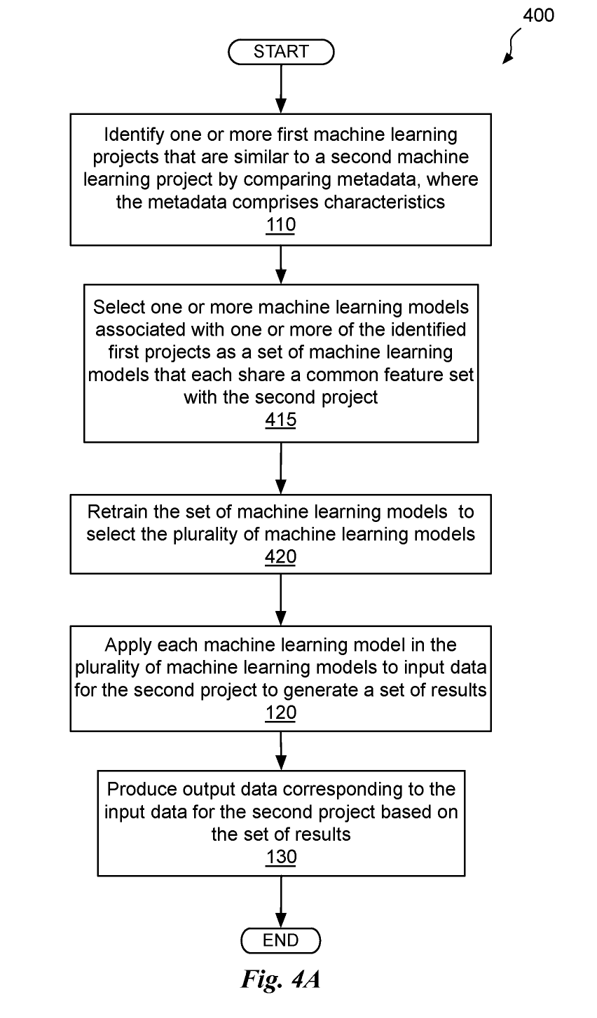

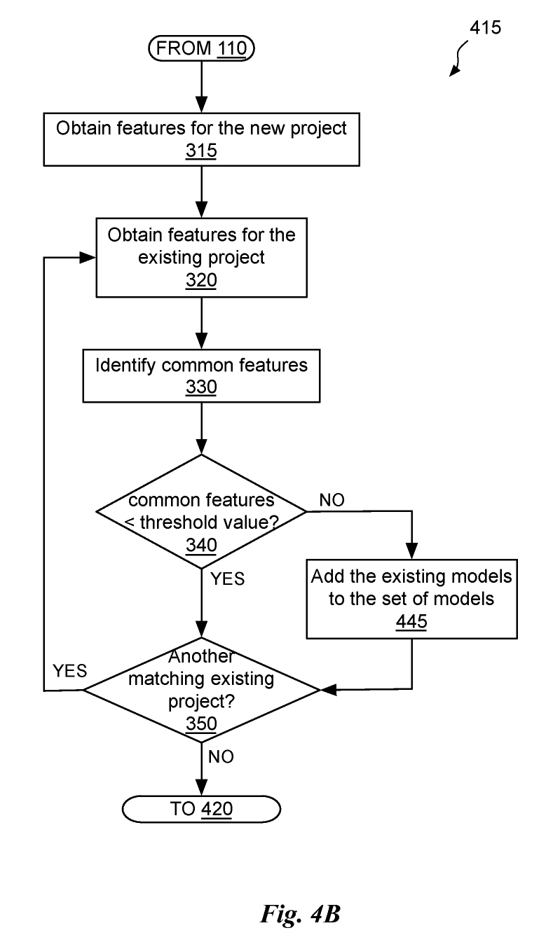

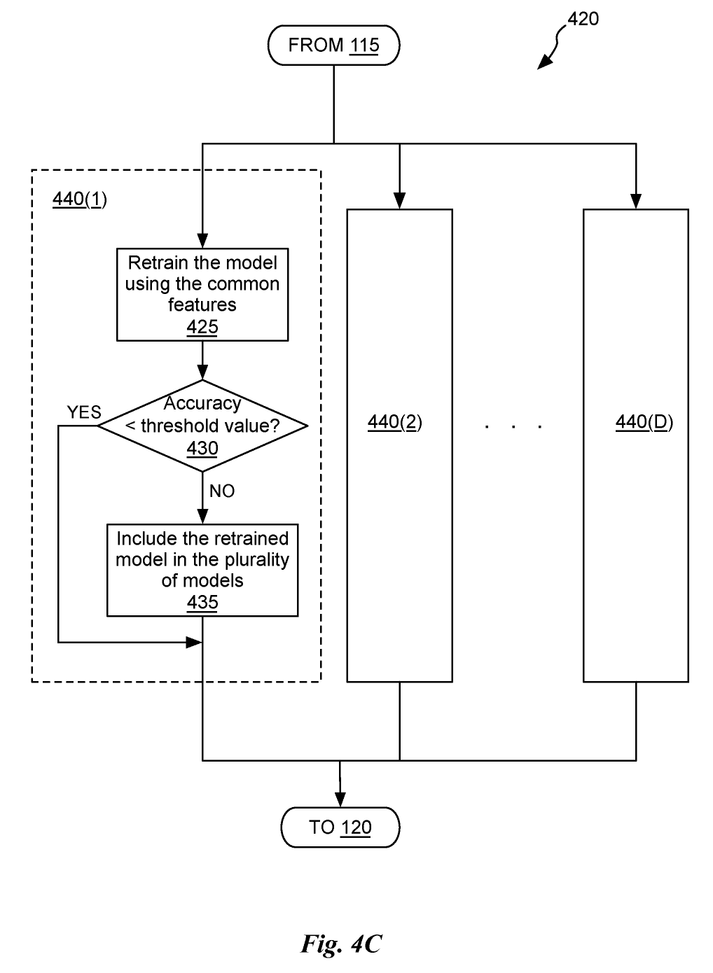

The model metadata 215 may be used by the ensemble transfer learning engine 210 to generate the plurality of models 235. The plurality of models 235 includes one or more models 240 that are selected from a set of models. The set of models includes existing models 230 that are associated with existing projects 225 and are selected by the ensemble transfer learning engine 210 based on a similarity to the new project 250. As described in conjunction with FIG. 4, in one embodiment, each model 240 in the plurality of models 235 may be retrained using only the common features (i.e. features shared by the new project 250 and the model 240). If the accuracy of the retrained model 240 is not above a threshold value, the ensemble transfer learning engine 210 may exclude the retrained model 240 from the plurality of machine learning models 235. In one embodiment, the models 240 in the plurality of models 235 are retrained versions of corresponding existing models 230 that are included in the set of models.

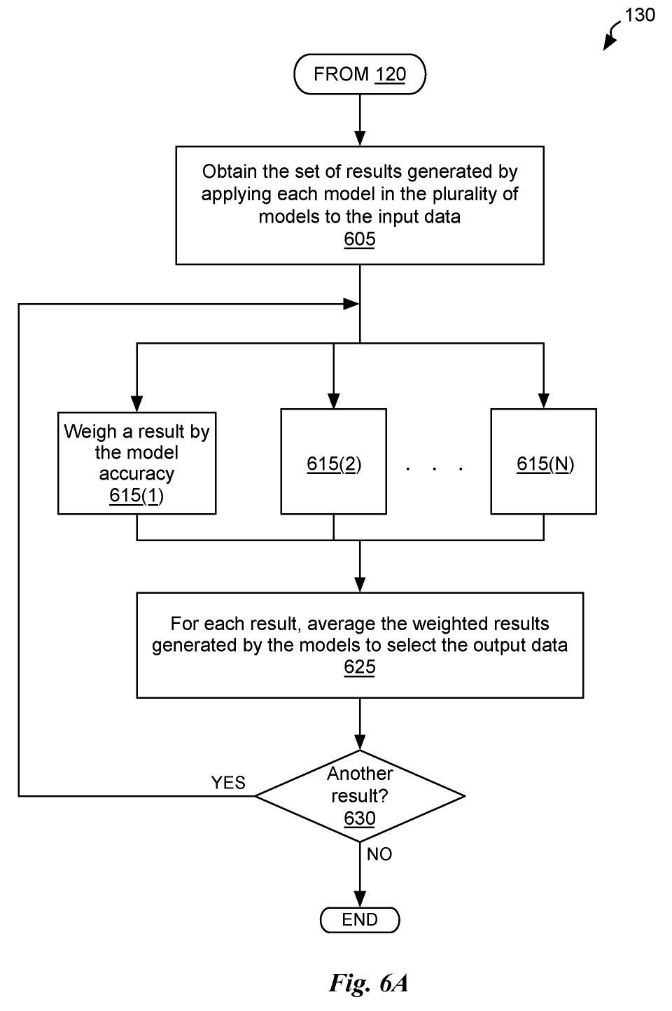

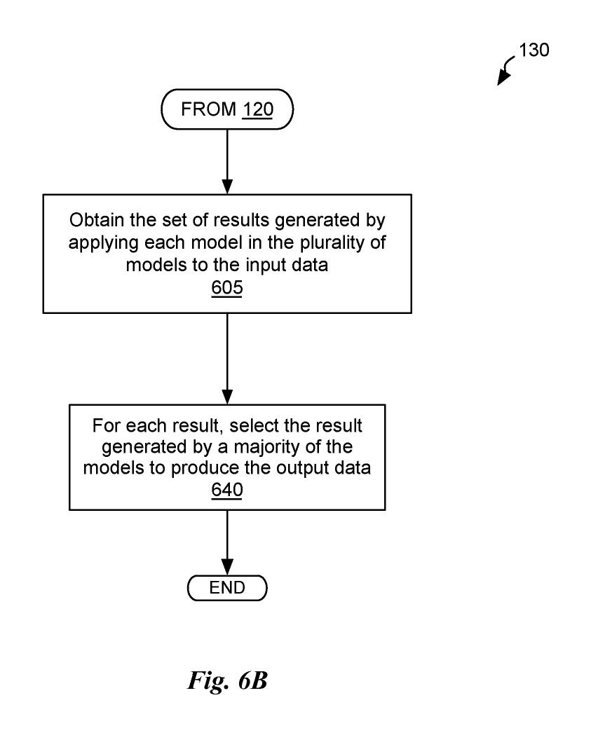

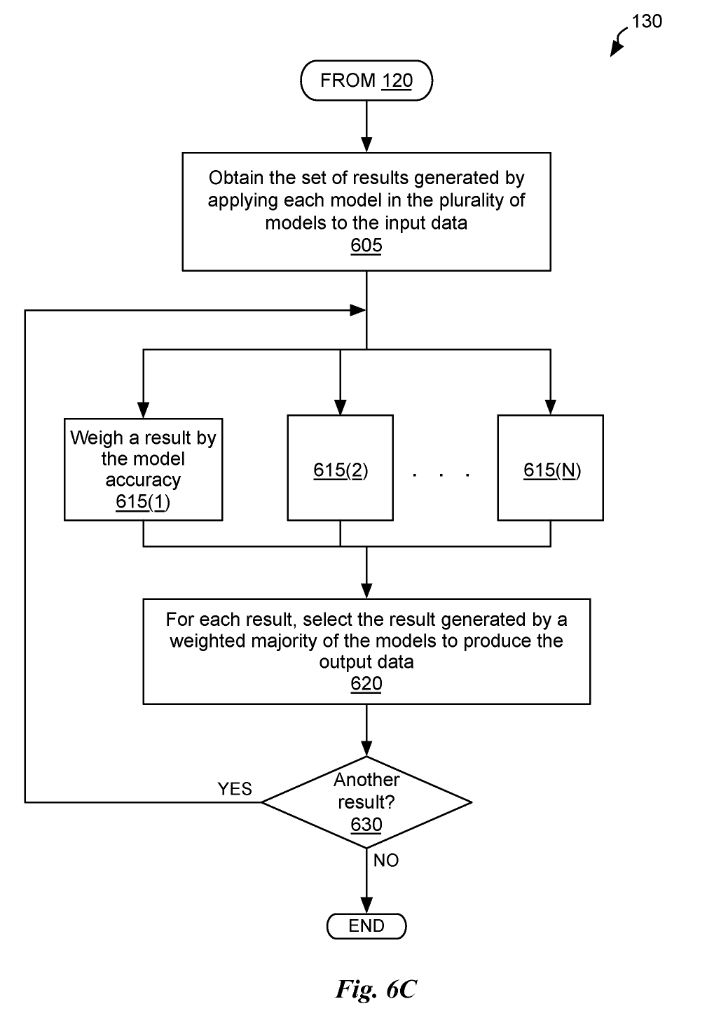

The models 240 are deployed by the ensemble transfer learning engine 210 and applied to the input data 255 for the new project 250 to generate a set of results. Output data 265 that corresponds to the input data 255 is generated by the ensemble transfer learning engine 210 based on the set of results. Generation of the output data 265 is described in conjunction with FIGS. 6A, 6B, and 6C. A new project dataset for the new project 250 includes the models 240 included in the plurality of models 235, input data 255, output data 265, model metadata 215 associated with the plurality of models 235, and project metadata 205 associated with the new project 250.

In various embodiments, the ensemble transfer learning engine 210 may include, but is not limited to at least one processor and any software controlling the same, and/or any other circuitry capable of the aforementioned functionality. The ensemble transfer learning engine 210 may be configured to compare the project metadata 205 to the new project 250 and to also compare the model metadata 215 to the new project 250 to select at least one existing project 225 that is similar to the new project 250. The ensemble transfer learning engine 210 then produces the plurality of models 235, where each model 240 in the plurality of models 235 is included in the at least one existing project 225.

The ensemble transfer learning platform 200 enables selection of one or more models 240 for a new project 250 based on a comparison between the existing projects 225 and the new project 250. The ensemble transfer learning platform 200 enables generation of a plurality of models 235 for the new project 250 even when the new project 250 has little or no training data. In one embodiment, the ensemble transfer learning platform 200 is a cloud ensemble transfer learning platform where one or more of the components of the storage and/or ensemble transfer learning engine 210 of the ensemble transfer learning platform 200 are distributed between different storage and/or computing resources.

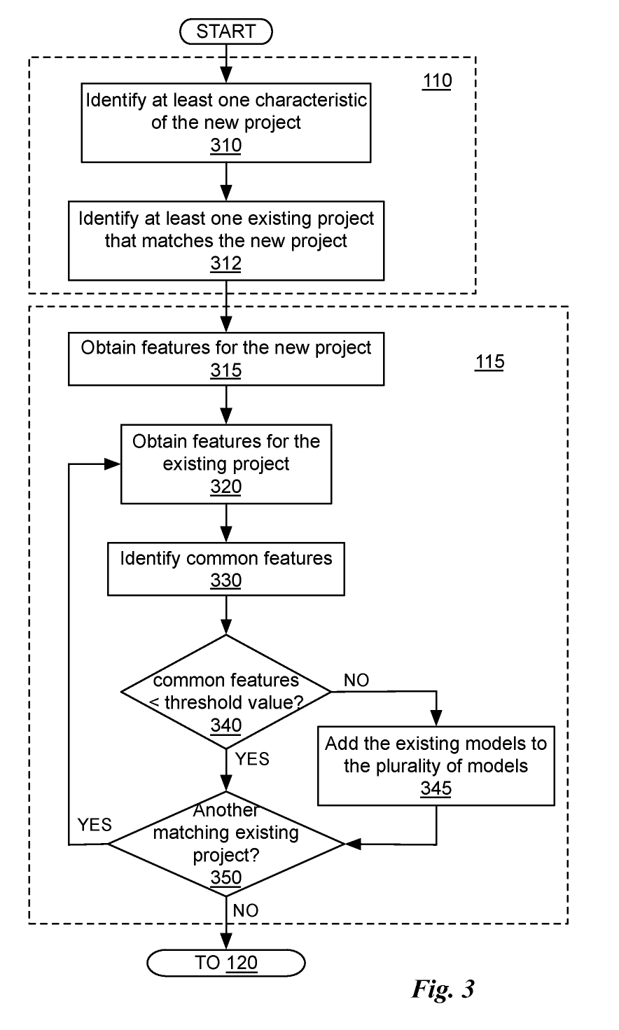

FIG. 3 illustrates the operations 110 and 115 of the method 100 shown in FIG. 1, in accordance with one embodiment. In the context of the following description, existing projects 225 that are similar to the new project 250 match the new project 250. In operation 310, the ensemble transfer learning engine 210 identifies at least one characteristic of the new project 250. In one embodiment, the at least one characteristic is included in the input data 255 and is stored in the project metadata storage 205. In one embodiment, one or more keywords are included in the input data 255 and are stored in the project metadata storage 205. In one embodiment, an existing project 225 matches the new project 250 when the projects are associated with the same characteristic. One or more elements of the project metadata for an existing project 225 or a new project 250 may be used as a characteristic for the existing project 225 or the new project 250, respectively. Other project metadata that may be included in the input data 255 and stored in the project metadata storage 205 includes a vertical industry (e.g., telecom, healthcare, finance etc.), problem goals, and one or more specific problem details. Examples of problem goals for the telecom industry include managing customers or improving the network. Examples of specific problem details for managing customers include churn predictions or predictions of whether a customer likes a specific product.

In operation 312, the ensemble transfer learning engine 210 identifies at least one existing project 225 that matches the new project 250. In operation 315, the ensemble transfer learning engine 210 obtains features for the new project 250. In one embodiment, the features are included in the input data 255 and are stored in the project metadata storage 205. Examples of features related to credit card transactions that may be included in the input data 255 and used to detect fraud may include: the amount of the credit transaction, the state/city of the transaction, whether or not the transaction occurs in foreign country, whether the transaction is a cash withdraw at an ATM, the number of times or entering wrong PINs (personal identification number), etc. In different projects, a feature that is the same may be named differently. Therefore, in one embodiment, the ensemble transfer learning engine 210 uses a knowledge database for disambiguation of the features. In one embodiment, the value distribution of a feature can be used by the ensemble transfer learning engine 210 to identify a feature that is the same in different projects, but named differently. For example, “throughput” in the dataset for an existing project 225 may be referred to as “data sending rate” in the new project 250.

Operations 320 through 350 are completed for each existing project 225 identified by the ensemble transfer learning engine 210 in operation 312. In one embodiment, as shown in FIG. 3, operations 320 through 350 are repeated for each existing project 225 identified in operation 312. Alternatively, operations 320 through 350 are performed in parallel for the existing projects 225 identified in operation 312. In operation 320, the ensemble transfer learning engine 210 obtains features for the existing project 250.

In operation 330, the ensemble transfer learning engine 210 identifies common features that are included in both the existing project 225 and the new project 250. In one embodiment, during training of one or more of the existing models 230 for an existing project 225, a subset of the features for the existing project 225 are selected. For example, features included in the subset may be those that contribute more significantly to a generating a correct label, compared with other features, when the existing models 230 are applied to input data. In one embodiment, all of the features for the existing project 225 may be considered during identification of the common features.

In operation 340, the ensemble transfer learning engine 210 determines if the number of features in the common features is less than a threshold feature count value. If the number of common features is below the threshold feature count value, then the ensemble transfer learning engine 210 proceeds to operation 350 and the existing models 120 associated with the existing project 225 are not included in the plurality of models 235. In other words, the existing project 225 is not considered to be a matching project for the new project 250 when the existing models 230 associated with the existing project 225 do not share a minimum number of features with the new project 250.

In one embodiment, in operation 340, the transfer learning engine 210 instead determines if a fraction (e.g., percentage) of features for the existing model 230 are also features for the new project 250. For example, in one embodiment, a threshold feature percentage value may be set at 50% and at least 50% of the features for the existing model 230 are also included in the new project 250. Specifically, when there are 600 features for the existing model 230 and at least 300 of the 600 features are the common features that are shared between the existing model 230 and the new project 250, the existing model 230 is not excluded from (i.e., is included in) the plurality of machine learning models 235. In contrast, when there are 600 features for the existing model 230 and less than 300 of the 600 features are the common features, the existing model is excluded from the plurality of machine learning models 235.

If, in operation 340, the number of common features is equal or greater than the threshold feature count value, then in operation 345, the existing models 230 for the existing project 225 that is similar to the new project 250 are added to the plurality of models 235. In operation 350, the ensemble transfer learning engine 210 determines if there is another existing project 225 in the ensemble transfer learning platform 200, and, if so, the ensemble transfer learning engine 210 returns to operation 315. If, in operation 350, the ensemble transfer learning engine 210 determines that there is not another existing project 225 in the ensemble transfer learning platform 200, then the ensemble transfer learning engine 210 proceeds to operation 120.

FIG. 4A illustrates another method 400 for performing ensemble transfer learning, in accordance with one embodiment. As an option, the method 400 may be implemented in the context of any one or more of the embodiments set forth in any previous and/or subsequent figure(s) and/or the description thereof. For example, in one possible embodiment, the method 400 may be implemented in the context of the ensemble transfer learning platform 200 of FIG. 2. However, it is to be appreciated that the method 400 may be implemented in other suitable environments.

The operation 110 is performed as previously described in conjunction with FIGS. 1 and 3. The operation 415 is similar to operation 115 except that one or more of the existing models 230 associated with the one or more of the identified existing projects 225 are included in a set of models. Details of the operation 415 is described in conjunction with FIG. 4B.

In operation 420 the plurality of machine learning models 235 are selected from the set of models after the set of models are retrained by the ensemble transfer learning platform 200. Details of the operation 420 is described in conjunction with FIG. 4C. The operation 120 is performed as previously described in conjunction with FIGS. 1 and 3. The operation 130 is performed as previously described in conjunction with FIG. 1.

FIG. 4B illustrates the operation 415 of the method 400 shown in FIG. 4A, in accordance with one embodiment. In operation 315, the ensemble transfer learning engine 210 obtains features for the new project 250. Operations 320 through 350 are completed for each existing project 225 identified by the ensemble transfer learning engine 210 as being similar to the new project 250. In one embodiment, as shown in FIG. 4B, operations 320 through 350 are repeated for each existing project 225 that is identified. Alternatively, operations 320 through 350 are performed in parallel for the existing projects 225 that are identified. The operation 320, the ensemble transfer learning engine 210 obtains features for the existing project 250.

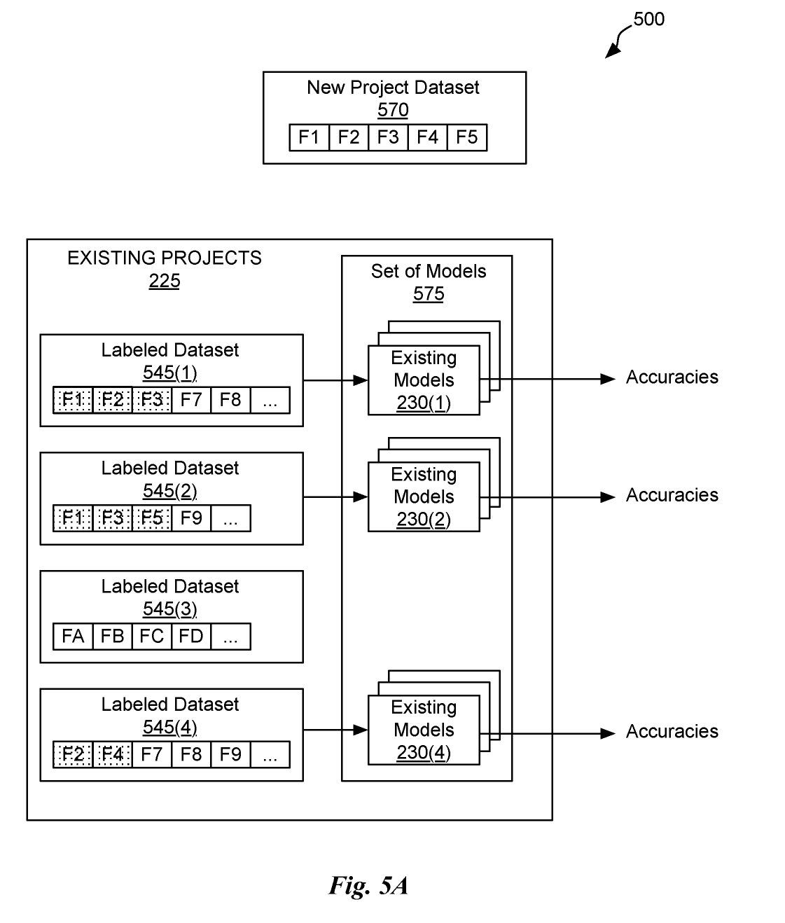

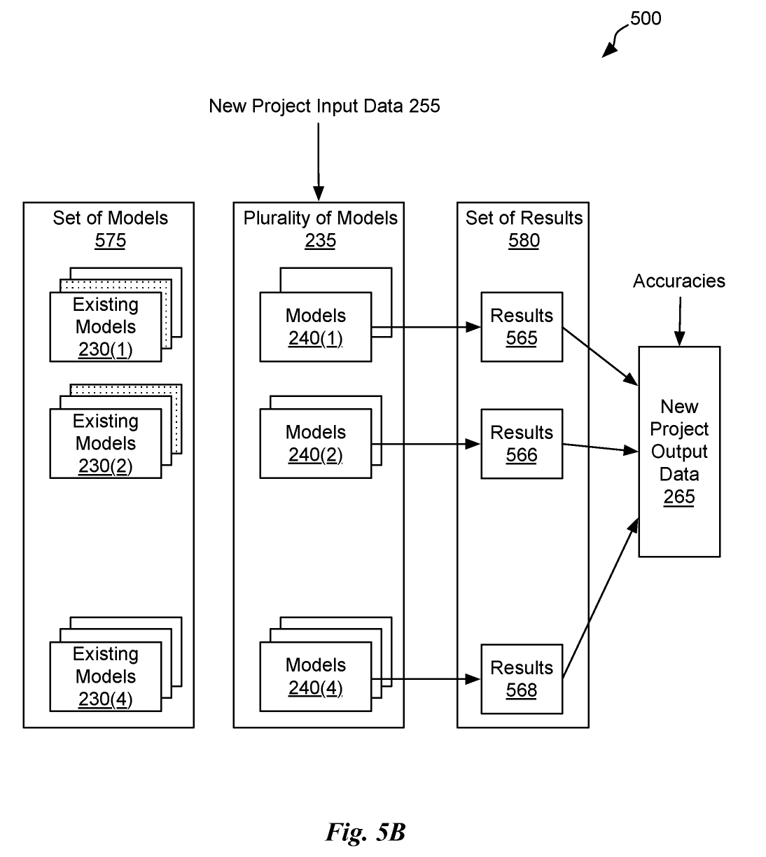

In operation 330, the ensemble transfer learning engine 210 identifies common features that are included in both the existing project 225 and the new project 250. In operation 340, the ensemble transfer learning engine 210 determines if the number of features in the common features is less than a threshold feature count value. If the number of common features is below the threshold feature count value, then the ensemble transfer learning engine 210 proceeds to operation 350 and the existing models 120 associated with the existing project 225 are not included in the set of models. As described in conjunction with FIG. 5B, the plurality of models 235 is selected from the set of models. In other words, the existing project 225 is not considered to be a matching project for the new project 250 when the existing models 230 associated with the existing project 225 do not share a minimum number of features with the new project 250.

If, in operation 340, the number of common features is equal or greater than the threshold feature count value, then in operation 445, the existing models 230 for the existing project 225 that is similar to the new project 250 are added to the set of models. In one embodiment, in operation 340, the transfer learning engine 210 instead determines if at least a fraction (e.g., percentage) of features for the existing models 230 are also features for the new project 250 to add the existing models 230 to the set of models.

In operation 350, the ensemble transfer learning engine 210 determines if there is another existing project 225 in the ensemble transfer learning platform 200, and, if so, the ensemble transfer learning engine 210 returns to operation 315. If, in operation 350, the ensemble transfer learning engine 210 determines that there is not another existing project 225 in the ensemble transfer learning platform 200, then the ensemble transfer learning engine 210 proceeds to operation 420.

FIG. 4C illustrates the generation of a plurality of models operation 115 shown in FIG. 4A, in accordance with one embodiment. As an option, the operation 115 may be implemented in the context of any one or more of the embodiments set forth in any previous and/or subsequent figure(s) and/or the description thereof. For example, in one possible embodiment, the operation 115 may be implemented in the context of the ensemble transfer learning platform 200 of FIG. 2. However, it is to be appreciated that the operation 115 may be implemented in other suitable environments.

The operation 440 includes operations 425, 430, and 435. The operation 440 is performed for each existing model 230 in the set of models. As shown in FIG. 4, there are D existing models 230 in the set of models, where D is an integer greater than or equal to 1. Therefore, one or more operations 440 may be executed simultaneously, where each instance of an operation 440 is associated with one of the D existing models 230.

In operation 425, the ensemble transfer learning engine 210 retrains the existing model 230 using the common features. In one embodiment, features that are not included in the common features are removed from a dataset that includes labels (i.e., a labeled dataset) for the existing project 225 to produce a modified training dataset. The modified training dataset may also include the input data and labels included in the labeled dataset. The existing model 230 is retrained by applying the existing model 230 to the input data to produce results. The results produced by the existing model 230 may be compared to the labels in the modified training dataset and the accuracy of the existing model 230 may be measured. In one embodiment, prior to retraining a first one of the existing models 230 at operation 425, the ensemble transfer learning engine 210 may select a different algorithm for the first one of the existing models 230 based on the common features. In one embodiment, when all of the features for an existing model 230 are included in the common features, the existing model 230 is not retrained and operation 425 is not performed.

In operation 430, the ensemble transfer learning engine 210 compares the accuracy of the retrained existing model 230. If the accuracy is below the threshold accuracy value, then the ensemble transfer learning engine 210 proceeds to operation 120 and the existing model 120 is excluded from the plurality of models 235. In other words, the existing model 230 that has been retrained is not included as a model 240 for the new project 250 when the existing mode 230 does not satisfy a minimum accuracy level after being retrained.

Otherwise, if in operation 430 the ensemble transfer learning engine 210 determines that the accuracy of the retrained existing model 230 is equal to or greater than the threshold accuracy value, then the ensemble transfer learning engine 210 proceeds to operation 435. In operation 435, the existing model 230 that has been retrained is included as a model 240 in the plurality of models 235. In one embodiment, each model 240 in the plurality of models 235 is a retrained version of an existing model 230. In one embodiment, when the common features for an existing model 230 match the features used to train the existing model 230, the existing model 230 may be used as a model 240 without being retrained. After the models 240 are retrained in operation 425, the models 240 may be deployed in operation 120 to generate results in response to the input data 255 for the new project 250. The results are predicted labels that are generated based on the retraining.

FIGS. 5A and 5B illustrate a conceptual diagram 500 of ensemble transfer learning, in accordance with one embodiment. As shown in FIG. 5A, a dataset for the new project 250, the new project dataset 570 includes the features F1, F2, F3, F4, and F5. For the purpose of the following description, the number of features is limited to 5, but in practice, the number of features may be much greater than 5 or less than 5. A labeled dataset is included for each one of the existing projects 225 and the labeled datasets 545(1), 545(2), 545(3), and 545(4) are shown in FIG. 5A. The shaded features in each of the labeled datasets 545(1), 545(2), 545(3), and 545(4) are the common features for the labeled dataset that are identified by the ensemble transfer learning engine 210. For example, the common features for the labeled dataset 545(1) are the features F1, F2, and F3. The common features for the labeled dataset 545(2) are the features F1, F3, and F5. The common features for the labeled dataset 545(4) are the features F2 and F4. There are no common features in the labeled dataset 545(3).

The existing models 230 associated with each labeled dataset 545 for which a minimum number of common features are identified by the ensemble transfer learning engine 210 are included in the set of models 575. In one embodiment, the existing models 230 associated with each labeled dataset 545 for which a fraction of features for the existing models 230 that are also features for the new project 250 is greater than a threshold value are included in the set of models 575. For example, the existing models 230(1) that are associated with the labeled dataset 545(1), the existing models 230(2) that are associated with the labeled dataset 545(2), and the existing models 230(4) that are associated with the labeled dataset 545(4) are included in the set of models 575. Each one of the existing models 230 is retrained using the common features for the existing project 225 associated with the existing model 230. For example, the ensemble transfer learning engine 210 retrains the existing models 230(1) using the common features F1, F2, and F3. The ensemble transfer learning engine 210 retrains the existing models 230(2) using the common features F1, F3, and F5. The ensemble transfer learning engine 210 retrains the existing models 230(4) using the common features F2 and F4. The ensemble transfer learning engine 210 measures an accuracy for each one of the retrained existing models 230.

As shown in FIG. 5B, the set of models 575 includes the existing models 230(1), 230(2), and 230(4). Based on the corresponding accuracies of the retrained models 230, one existing model 230(1) and one existing model 230(2) are shaded with a hatching pattern and are excluded from (i.e., not included in) the plurality of models 235. More specifically, the accuracies of the one existing model 230(1) and one existing model 230(2) was less than a minimum accuracy defined by the threshold accuracy value. The ensemble transfer learning engine 210 includes the retrained existing models 230(1), 230(2), and 230(4) having accuracies that are equal or greater to the minimum accuracy by the threshold accuracy value in the plurality of models 235 as the models 240(1), 240(2), and 240(4), respectively.

The ensemble transfer learning engine 210 applies each of the existing models 240 in the plurality of models 235 to the input data 255 of the new project 250 to generate a set of results 580 including results 565, 566, and 568. The results 565, 566, and 568 are produced by the models 240(1), 240(2), and 240(4), respectively.

The results 580 are predictions based on the models 240 and each result corresponds to an accuracy measured for the model 240 by the ensemble transfer learning engine 210 during the retraining. In one embodiment, as described in conjunction with FIG. 6A, the ensemble transfer learning engine 210 weighs each result by the corresponding retrained accuracy and then averages the weighted results to produce an output value. For example, a first result in results 565 is weighed by the retrained accuracy measured for the model 240(1) that produced the first result to compute a weighted first result value. Additional weighted first result values are computed for each model 240 in the plurality of models 235. The first result value and the additional weighted first result values are then averaged to compute a first output value for the new project 250. Thus, the output data 265 (shown in FIG. 2) for the new project 250 includes the output values that are produced by a combination (i.e., ensemble) of the models 240.

FIG. 6A illustrates the operation 130 of the method 100 shown in FIG. 1, in accordance with one embodiment. In operation 605, the ensemble transfer learning engine 210 obtains the set of results 580 generated by applying each model 240 in the plurality of models 235 to the input data 255 for the new project 250. The operation 615 is performed for each model 240 in the plurality of models 235 produced by the ensemble transfer learning engine 210. As shown in FIG. 6A, there are N models 240 in the plurality of models 235, where N is an integer greater than or equal to 1. Therefore, one or more operations 615 may be executed simultaneously, where each instance of an operation 615 is associated with one of the N models 240.

In operation 615, the ensemble transfer learning engine 210 weighs a result by the retrained accuracy for the model 240. In one embodiment, each result is a numerical value, such as a probability (between 0 and 1), integer (e.g., age), floating point, etc. At operation 625, the output data 265 is produced. Specifically, for each result, the ensemble transfer learning engine 210 averages the weighted results computed at operation 615 to produce the output data 265. Each model 240 may generate one or more results in response to the input data 255. In operation 630, ensemble transfer learning engine 210 determines if there is another result generated by the model 240. If there is another result, then the ensemble transfer learning engine 210 returns to operation 615. Otherwise, production of the output data 265 for the new project 250 is complete.

FIG. 6B illustrates another operation 130 of the method 100 shown in FIG. 1, in accordance with one embodiment. The output data production operation 130 shown in FIG. 6B is an alternative to the output data production operation 130 shown in FIG. 6A. When the results are multi-categorical values (e.g., orange, apple, banana, etc.), binary values, or true/false values instead of numerical values, the output data production operation 130 shown in FIG. 6B may be used to produce the output data 265.

In operation 605, the ensemble transfer learning engine 210 obtains the set of results 580 generated by applying each model 240 in the plurality of models 235 to the input data 255 for the new project 250. In operation 640, for each result, the ensemble transfer learning engine 210 selects the result value generated by the majority of the models 240 to produce the output data 265. In other words, for each result, the models 240 “vote” to determine the output data 265.

FIG. 6C illustrates yet another operation 130 of the methods 100 shown in FIG. 1, in accordance with one embodiment. The output data production operation 130 shown in FIG. 6C is an alternative to the output data production operation 130 shown in FIGS. 6A and 6B. When the results are multi-categorical values instead of either binary or true/false values, the output data production operation 130 shown in FIG. 6C may be used to produce the output data 265.

In operation 605, the ensemble transfer learning engine 210 obtains the set of results 580 generated by applying each model 240 in the plurality of models 235 to the input data 255 for the new project 250. As previously described in conjunction with FIG. 6A, the operation 615 is performed for each model 240 in the plurality of models 235 selected by the ensemble transfer learning engine 210. In operation 615, the ensemble transfer learning engine 210 weighs a result by the retrained accuracy for the model 240.

At operation 620, the output data 265 is produced. Specifically, for each result, the ensemble transfer learning engine 210 sums the weighted results computed at operation 615 for each label to select a result generated by a weighted majority of the models 240 as the output data 265. For example, if a label A is predicted by three models 240 (i.e., the three models 240 vote for label A) associated with weights (0.2, 0.3, 0.5) and a label B is predicted by two models 240 associated with weights (0.7, 0.8), the label A receives a weighted vote equal to 1.0 and the label B receives a weighted vote equal to 1.5. Because label B has a weighted majority of the votes, label B is selected as the result. In contrast, when a strict majority voting scheme is used, as described in conjunction with FIG. 6B, label A is selected as the result because label A has the majority of the five votes.

Each model 240 may generate one or more results in response to the input data 255. In operation 630, ensemble transfer learning engine 210 determines if there is another result generated by the model 240. If there is another result, then the ensemble transfer learning engine 210 returns to operation 615. Otherwise, production of the output data 265 for the new project 250 is complete.

The ensemble transfer learning platform 200 leverages existing machine learning projects 225 to guide the modeling of a new project 250, effectively transferring learning from the existing projects 225 to the new project 250. The models 240 in the plurality of models 235 that are selected by the ensemble transfer learning engine 210 form an ensemble machine learning model for the new project 250. The need for expertise and experience of a data analyst for the new project 250 is reduced, enabling faster development and deployment of models 240 for the new project 250. The ensemble transfer learning platform 200 enables the reuse of existing projects 225 and existing models 230 rather than generating new models for the new project 250. The computationally intensive and time-consuming tasks of developing a new machine learning model are reduced by reusing the existing models 230.

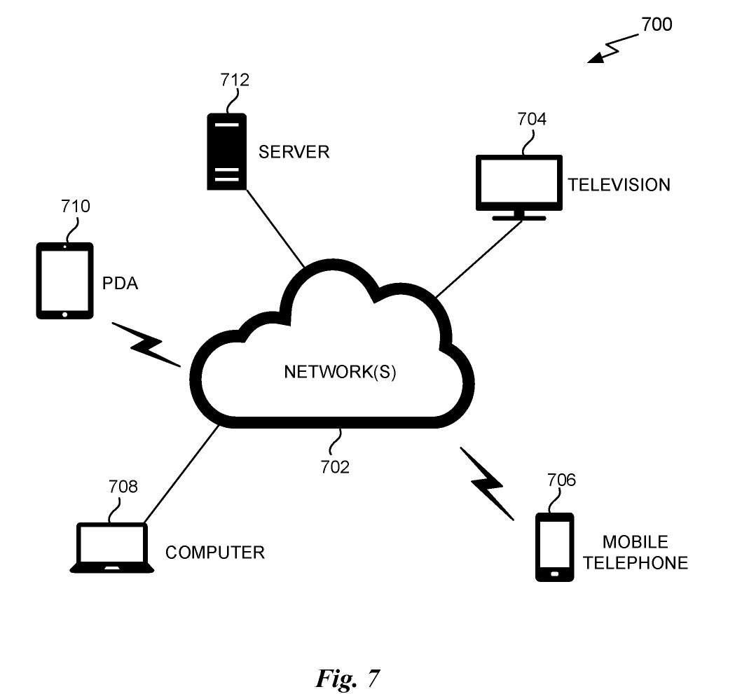

FIG. 7 is a diagram of a network architecture 700, in accordance with an embodiment. As shown, at least one network 702 is provided. In various embodiments, any one or more components/features set forth during the description of any previous figure(s) may be implemented in connection with any one or more components 704-712 coupled to the at least one network 702. For example, in various embodiments, any of the components 704-712 may be equipped with one or more of components of the ensemble transfer learning platform 200 of FIG. 2, for managing knowledge and generating recommendations.

In the context of the present network architecture 700, the network 702 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 702 may be provided.

Coupled to the network 702 is a plurality of devices. For example, a server 712 and a computer 708 may be coupled to the network 702 for communication purposes. Such computer 708 may include a desktop computer, laptop computer, and/or any other type of logic. Still yet, various other devices may be coupled to the network 702 including a personal digital assistant (PDA) device 710, a mobile phone device 706, a television 704, etc.

In one embodiment, the ensemble transfer learning platform 200 is implemented in a cloud environment and is managed in a cloud architecture that includes many different services. Related engines and business logic may be implemented in the cloud services to provide high-availability, high-reliability and low-latency. In one embodiment, a metadata service stores and manages all data associated with existing projects 225 and new projects 250. In one embodiment, a distributed and scalable storage service is implemented for existing projects 225, new projects 250, and related data.

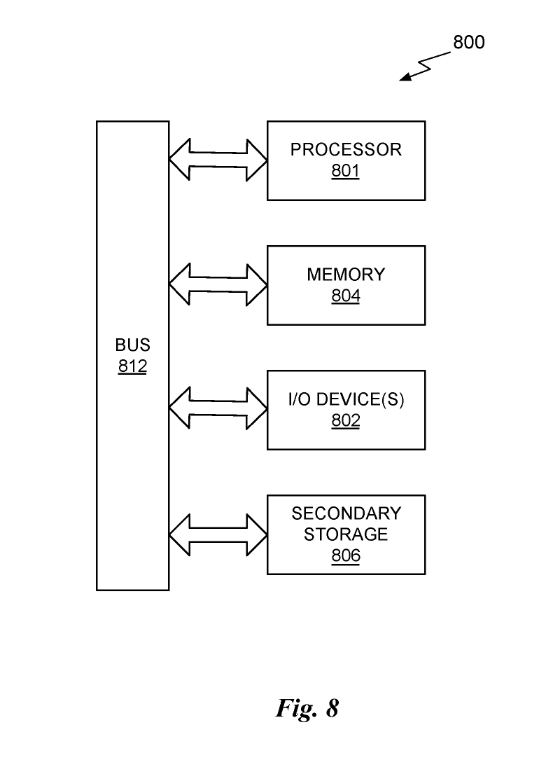

FIG. 8 illustrates an exemplary processing system 800, in accordance with one embodiment. As shown, a processing system 800 is provided including a plurality of devices that are connected to a communication bus 812. The devices include a processor 801, a memory 804, input/output (I/O) device(s) 802, and a secondary storage 806. The communication bus 812 may be implemented using any suitable protocol. One or more of the processor 801, memory 804, and a secondary storage 806 may be configured to implement the managed knowledge network platform 200.

The processing system 800 also includes the memory 804 (e.g. random access memory (RAM), etc.). The processing system 800 may also include the secondary storage 806. The secondary storage 806 includes, for example, a hard disk drive and/or a removable storage drive, a floppy disk drive, a magnetic tape drive, a compact disk drive, etc. The removable storage drive reads from and/or writes to a removable storage unit in a well-known manner. The processing system 800 may also include the I/O device(s) 802. Output devices may include a conventional CRT (cathode ray tube), LCD (liquid crystal display), LED (light emitting diode), plasma display or the like. User input may be received from the I/O device(s) 802, e.g., keyboard, mouse, touchpad, microphone, gaze tracking, and the like.

Computer programs, or computer control logic algorithms, may be stored in the memory 804, the secondary storage 806, and/or any other memory, for that matter. Such computer programs, when executed, enable the processing system 800 to perform various functions (as set forth above including, but not limited to those of a managed knowledge network platform 200, for example). Memory 804, secondary storage 806 and/or any other storage are possible examples of tangible computer-readable media.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), or the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, or electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; or the like.

Computer-readable non-transitory media includes all types of computer readable media, including magnetic storage media, optical storage media, and solid state storage media and specifically excludes signals. It should be understood that the software can be installed in and sold with the devices described herein. Alternatively the software can be obtained and loaded into the devices, including obtaining the software via a disc medium or from any manner of network or distribution system, including, for example, from a server owned by the software creator or from a server not owned but used by the software creator. The software can be stored on a server for distribution over the Internet, for example.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the embodiments as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A processing device, comprising:
a non-transitory memory storing instructions; and
one or more processors in communication with the non-transitory memory, wherein the one or more processors execute the instructions to:
identify one or more first machine learning projects that are similar to a second machine learning project by comparing metadata of the one or more first machine learning projects and the second machine learning project, wherein the metadata comprises a plurality of characteristics and the characteristics of the first machine learning projects are compared to the characteristics of the second machine learning project to identify the one or more first machine learning projects;
select one or more machine learning models associated with the one or more first machine learning projects as a plurality of machine learning models that each share a common feature set with the second machine learning project;
apply each machine learning model in the plurality of machine learning models to input data for the second machine learning project to generate a set of results; and
produce output data corresponding to the input data for the second machine learning project based on the set of results.

2. The processing device of claim 1, wherein the one or more processors execute the instructions to select the plurality of machine learning models from a set of machine learning models including machine learning models associated with the one or more first machine learning projects.

3. The processing device of claim 2, wherein the one or more processors execute the instructions to compare a training dataset of each machine learning model in the set of machine learning models to the input data to select the plurality of machine learning models.

4. The processing device of claim 2, wherein the one or more processors execute the instructions to compare features in a training dataset of each machine learning model in the set of machine learning models with features in the input data to identify the common feature set including at least a minimum number of features shared between each machine learning model in the set of machine learning models and the second machine learning project.

5. The processing device of claim 2, wherein the one or more processors execute the instructions to compare features in a training dataset of each machine learning model in the set of machine learning models with features in the input data to identify the common feature set including features shared between machine learning models in the set of machine learning models and the second machine learning project.

6. The processing device of claim 5, wherein the one or more processors execute the instructions to exclude machine learning models in the set of machine learning models for which a number of features in the common feature set is less than a threshold value to produce the plurality of machine learning models.

7. The processing device of claim 2, wherein the one or more processors execute the instructions to exclude each machine learning model in the set of machine learning models for which a fraction of features for the machine learning model that are also features for the second project is less than a threshold value to produce the plurality of machine learning models.

8. The processing device of claim 1, wherein the one or more processors execute the instructions to retrain each machine learning model in the plurality of machine learning models using the common feature set before the machine learning model is applied to the input data.

9. The processing device of claim 1, wherein the one or more processors execute the instructions to:
determine the input data is not associated with a first feature;
remove the first feature from a training dataset for a first machine learning model in the plurality of machine learning models to produce a modified training dataset; and
retrain the first machine learning model using the modified training dataset.

10. The processing device of claim 9, wherein the one or more processors execute the instructions to:
evaluate accuracy of the retrained first machine learning model; and
before applying the first machine learning model to the input data, exclude the retrained first machine learning model from the plurality of machine learning models when the accuracy is less than a threshold value.

11. The processing device of claim 1, wherein the one or more processors execute the instructions to:
for each machine learning model in the plurality of machine learning models, weigh a result value in the set of results that is produced by the machine learning model by an accuracy of the machine learning model to produce a set of weighted result values; and
average the weighted result values to produce the output data.

12. The processing device of claim 1, wherein the one or more processors execute the instructions to, for each one of the result values in the set of results, select a result value that is predicted by a majority of the plurality of machine learning models to produce the output data.

13. The processing device of claim 1, wherein the one or more processors execute the instructions to, for each one of the result values in the set of results, select a result value that is predicted by a weighted majority of the plurality of machine learning models to produce the output data.

14. A computer-implemented method comprising:
identifying one or more first machine learning projects that are similar to a second machine learning project by comparing metadata of the one or more first machine learning projects and the second machine learning project, wherein the metadata comprises a pluraliry of characteristics and the characteristics of the first machine learning projects are compared to the characteristic of the second machine learning project to identify the one or more first machine learning projects;
selecting one or more machine learning models associated with the one or more first machine learning projects as a plurality of machine learning models that each share a common feature set with the second machine learning project;
applying each machine learning model in the plurality of machine learning models to input data for the second machine learning project to generate a set of results; and
producing output data corresponding to the input data for the second machine learning project based on the set of results.

15. The method of claim 14, further comprising selecting the plurality of machine learning models from a set of machine learning models including machine learning models associated with the one or more first machine learning projects.

16. The method of claim 15, further comprising comparing a training dataset of each machine learning model in the set of machine learning models to the input data to select the plurality of machine learning models.

17. The method of claim 14, further comprising retraining each machine learning model in the plurality of machine learning models using the common feature set before the machine learning model is applied to the input data.

18. A non-transitory computer-readable media storing computer instructions, that when executed by one or more processors, cause the one or more processors to perform the steps of:
identifying one or more first machine learning projects that are similar to a second machine learning project by comparing metadata of the one or more first machine learning projects and the second machine learning project, wherein the metadata comprises a plurality of characteristics and the characteristics of the first machine learning projects are compared to the characteristic of the second machine learning project to identify the one or more first machine learning projects;
selecting one or more machine learning models associated with the one or more first machine learning projects as a plurality of machine learning models that each share a common feature set with the second machine learning project;
applying each machine learning model in the plurality of machine learning models to input data for the second machine learning project to generate a set of results; and
producing output data corresponding to the input data for the second machine learning project based on the set of results.

19. The non-transitory computer-readable media of claim 18, the steps further comprising selecting the plurality of machine learning models from a set of machine learning models including machine learning models associated with the one or more first machine learning projects.

20. The non-transitory computer-readable media of claim 18, the steps further comprising retraining each machine learning model in the plurality of machine learning models using the common feature set before the machine learning model is applied to the input data.
